(19) United States
(12) Patent Application Publication
(10) Pub. No.: US 2026/0300307 A1
(43) Pub. Date: Oct. 1, 2026

(54) POLICY MAKING SUPPORT APPARATUS, METHOD, AND PROGRAM

(71) Applicant: Hitachi, Ltd., Tokyo (JP)

(72) Inventors: Takayuki HABUCHI, Tokyo (JP); Yoshinori SATO, Tokyo (JP); Tomoki ISHII, Tokyo (JP)

(21) Appl. No.: 19/542,065

(22) Filed: Feb. 17, 2026

(30) Foreign Application Priority Data
Mar. 25, 2025 (JP) 2025-050489

(51) Int. Cl. G06F 16/2457

(52) U.S. Cl. CPC G06F 16/24578

(57) ABSTRACT

A policy making support apparatus, method, and program are able to support making realistic and effective policies. A storage device of the policy making support apparatus stores a statistical data database that holds information related to a logic model that includes a final outcome, intermediate outcomes, and initial outcomes, and statistical data related to a policy. An individual data database holds individual data items related to the policy. All the intermediate outcomes that significantly affect a final outcome externally selected as an improvement target are extracted based on the logic model and the statistical data, and an intermediate outcome that is inferior to a preset comparable item is extracted as an improvement indicator candidate from among the extracted intermediate outcomes. A trial calculation of an effect expected when the extracted improvement indicator candidate is improved is made, and a trial calculation result is displayed.

### CROSS-REFERENCE TO RELATED APPLICATION

The present application claims priority from Japanese application JP2025-050489, filed on Mar. 25, 2025, the content of which is hereby incorporated by reference into this application.

### BACKGROUND OF THE INVENTION

### Field of the Invention

The present invention relates to a policy making support apparatus, method, and program, and is suitable for application in a policy making support apparatus that supports EBPM (Evidence-Based Policy Making), for example.

### Description of the Related Art

In recent years, EBPM that clarifies policy goals, and then makes a policy based on evidence has been attracting attention. EBPM often employs a logic model that represents the relationship between inputs, outputs (activities), and initial, intermediate and final outcomes (effects) in order to clarify the logic between inputs and outputs of the policy, and the outcomes that are policy goals.

As a technique in this field, for example, Patent Literature 1 discloses a method of evaluating a policy on the basis of quantification of social impacts based on the logic model.

### Citation List

### Patent Literature

Patent Literature 1: JP-2023-167759 A

However, it is difficult to empirically determine which indicators are related to the final outcome among initial outcomes and intermediate outcomes, which indicators have room for improvement, and whether the improvement of the indicators is realistic.

In this respect, conventionally, a method of quantitatively representing the relationship between the initial outcomes and the intermediate outcomes has been proposed. Through use of this method, indicators that are related to the final outcome and are inferior to comparable items can be found. There is however a problem that it is difficult to determine whether the improvement of the indicators is realistic or not based on the logic model represented by the statistical values.

Consequently, if it can be comprehensively determined which indicators are related to the final outcome, which indicators have room for improvement, and which indicators can be realistically improved, among the initial outcomes and intermediate outcomes in EBPM, it is conceivable that realistic and effective policies can be made.

The present invention has been made in consideration of the above points, and is to propose a policy making support apparatus, method, and program that can support making realistic and effective policies.

### SUMMARY OF THE INVENTION

To solve these problems, in the present invention, a policy making support apparatus supporting making a policy includes: a storage device that stores a program; and a processor that executes a predetermined computation process, based on the program stored in the storage device, wherein the storage device stores a statistical data database that holds information related to a logic model that includes a final outcome, intermediate outcomes, and initial outcomes, and statistical data related to the policy, and an individual data database that holds individual data items related to the policy, along with the program, and the processor: extracts all the intermediate outcomes that significantly affect the final outcome externally selected as an improvement target, based on the logic model and the statistical data, and extracts the intermediate outcome that is inferior to a preset comparable item from among the extracted intermediate outcomes, as an improvement indicator candidate; and makes a trial calculation of an effect expected when the extracted improvement indicator candidate is improved, and displays a trial calculation result.

Furthermore, in the present invention, a policy making support method is executed by a policy making support apparatus supporting making a policy, wherein the policy making support apparatus includes: a storage device that stores a program; and a processor that executes a predetermined computation process, based on the program stored in the storage device, and the storage device stores: a statistical data database that holds information related to a logic model that includes a final outcome, intermediate outcomes, and initial outcomes, and statistical data related to the policy, and an individual data database that holds individual data items related to the policy, along with the program; and the method includes: a first step of causing the processor to extract all the intermediate outcomes that significantly affect the final outcome externally selected as an improvement target, based on the logic model and the statistical data, and extract the intermediate outcome that is inferior to a preset comparable item from among the extracted intermediate outcomes, as an improvement indicator candidate; and a second step of causing the processor to make a trial calculation of an effect expected when the extracted improvement indicator candidate is improved, and display a trial calculation result.

Moreover, in the present invention, a program causes a computer to execute a process, the computer including a storage device that stores a statistical data database that holds information related to a logic model that includes a final outcome, intermediate outcomes, and initial outcomes, and statistical data related to the policy, and an individual data database that holds individual data items related to the policy, wherein the process includes: a first step of extracting all the intermediate outcomes that significantly affect the final outcome externally selected as an improvement target, based on the logic model and the statistical data, and extracting the intermediate outcome that is inferior to a preset comparable item from among the extracted intermediate outcomes, as an improvement indicator candidate; and a second step of making a trial calculation of an effect expected when the extracted improvement indicator candidate is improved, and displaying a trial calculation result.

The policy making support apparatus, method, and program in the present invention allow a person in charge to easily recognize the intermediate outcome serving as a realistic improvement indicator candidate, and its improvement effect, based on the displayed trial calculation result.

### ADVANTAGEOUS EFFECTS OF THE INVENTION

According to the present invention, the policy making support apparatus, method, and program that can support making realistic and effective policies can be realized.

### BRIEF DESCRIPTION OF THE DRAWINGS

FIG. 1 is a block diagram showing the entire configuration of a policy making support system according to a first embodiment;

FIG. 2 is a conceptual diagram for describing a policy making support function according to the present embodiment;

FIG. 3 is a table showing a statistical data comparison table;

FIGS. 4A and 4B are graphs showing distribution examples of the number of applicable items of people with motor function impairment risk;

FIGS. 5A and 5B are graphs showing answer distribution examples of people with motor function impairment risk;

FIG. 6 is a table showing a configuration example of a statistical data table;

FIG. 7 is a table showing a configuration example of a node table;

FIG. 8 is a table showing a configuration example of a path table;

FIG. 9 is a table showing a configuration example of an individual data database;

FIG. 10 is a flowchart showing the flow of an improvement indicator candidate extraction process;

FIG. 11 is a flowchart showing the flow of an improvement effect trial calculation process;

FIG. 12 is a table showing a display example of an improvement effect trial calculation result;

FIG. 13 is a block diagram showing the entire configuration of a policy making support system according to a second embodiment;

FIG. 14 is a table showing a configuration example of an activity master table;

FIG. 15 is a table showing a configuration example of an output master table;

FIG. 16 is a table showing a configuration example of an input master table;

FIG. 17 is a table showing a configuration example of an activity-input relation table; and

FIG. 18 is a table showing a configuration example of an activity-output-outcome relation table.

### DETAILED DESCRIPTION OF THE INVENTION

Referring to the diagrams, an embodiment of the present invention is described in detail below.

### (1) First Embodiment

### (1-1) Configuration of Policy Making Support System in Present Embodiment

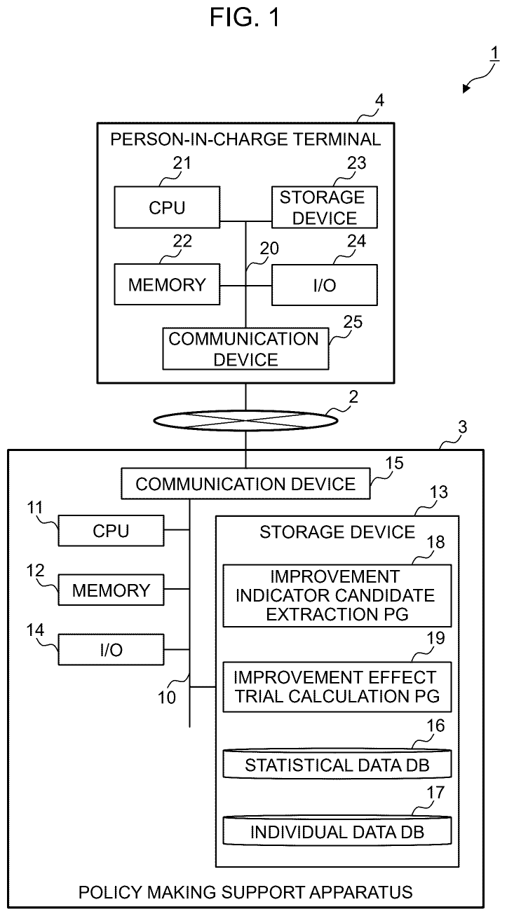

In FIG. 1, reference numeral 1 denotes a policy making support system according to the present embodiment as a whole. The policy making support system 1 includes a policy making support apparatus 3 and a person-in-charge terminal 4 that are coupled via a network 2, such as a LAN (Local Area Network) or a WAN (Wide Area Network).

The policy making support apparatus 3 is a computer apparatus in which a function of supporting EBPM (hereinafter, this is called a policy making support function) is implemented, and has a configuration including a CPU (Central Processing Unit) 11, a memory 12, a storage device 13, an I/O (Input/Output) interface 14, and a communication device 15, which are coupled to each other via an internal bus 10.

The CPU 11 is a processor that controls the operation of the entire policy making support apparatus 3. The memory 12 is made up of, for example, a semiconductor memory, such as RAM (Random Access Memory), and is used as a working memory for the CPU 11.

The storage device 13 is made up of a non-volatile storage device, such as a hard disk device, an SSD (Solid State Drive), and a multimedia card to be embedded, and is used to hold programs, and data required to be held for long periods. A statistical data database 16 and an individual data database 17, and an improvement indicator candidate extraction program 18 and an improvement effect trial calculation program 19, which are described later, are also stored and held in the storage device 13.

The programs stored in the storage device 13 are loaded from the storage device 13 to the memory 12 at the activation of the policy making support apparatus 3 and at the time of need, and the programs loaded in the memory 12 are executed by the CPU 11, thereby executing various processes by the entire policy making support apparatus 3 as described later.

The I/O interface 14 is an interface that inputs and outputs signals between an input device, such as a keyboard and a mouse, coupled to the policy making support apparatus 3, and an output device, such as a liquid crystal display or an organic EL (Electro-Luminescence) display. The communication device 15 is made up of, for example, an NIC (Network Interface Card) or the like, and performs protocol control during communication with the person-in-charge terminal 4 and other devices via the network 2.

The person-in-charge terminal 4 is a computer apparatus used when a person in charge of policy making in an organization serving as a target (hereinafter, this is called a target organization) makes a policy. The person in charge accesses the policy making support apparatus 3 using the person-in-charge terminal 4, and makes a policy using the policy making support function of the policy making support apparatus 3. The present embodiment is described below using an example of a case where the target organization is a certain municipality City A, and a staff member of City A serves as the person in charge, and makes a policy of nursing care insurance services using the policy making support system 1 in the present embodiment.

The person-in-charge terminal 4 has a configuration including a CPU 21, a memory 22, a storage device 23, an I/O interface 24, and a communication device 25, which are coupled to each other via an internal bus 20. These CPU 21, memory 22, storage device 23, I/O interface 24, and communication device 25 have functions and configurations that are similar to those of the CPU 11, the memory 12, the storage device 13, the I/O interface 14, and the communication device 15 of the policy making support apparatus 3. Accordingly, the description thereof is omitted here.

### (1-2) Policy Making Support Function in Present Embodiment

Next, the policy making support function implemented in the policy making support apparatus 3 in the present embodiment is described.

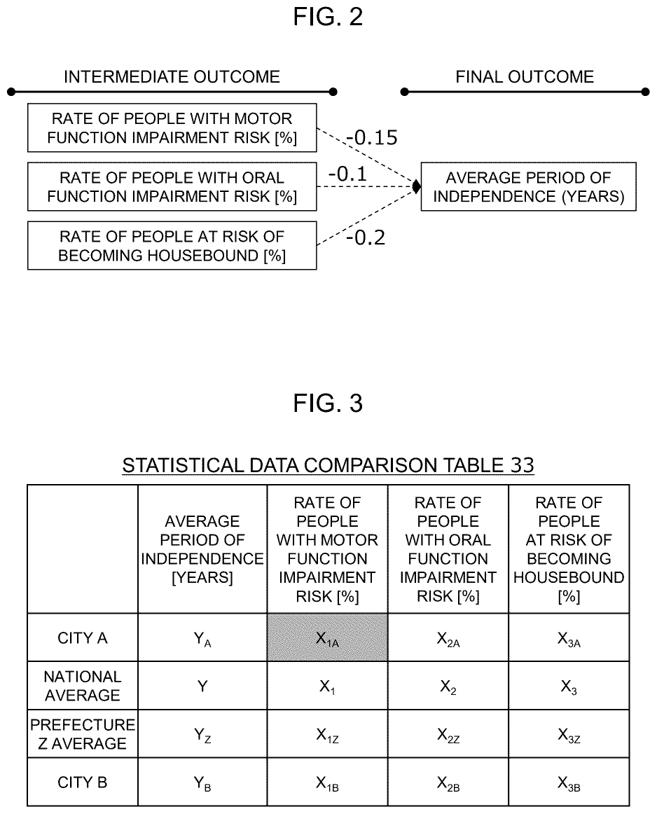

As shown in FIG. 2, the relationship between a final outcome that is an improvement goal, and intermediate outcomes that significantly contribute to the final outcome can be quantitatively evaluated by performing multiple regression analysis using statistical data and a logic model. In the example in FIG. 2, the intermediate outcomes that are “RATE OF PEOPLE WITH MOTOR FUNCTION IMPAIRMENT RISK [%]”, “RATE OF PEOPLE WITH ORAL FUNCTION IMPAIRMENT RISK [%]”, and “RATE OF PEOPLE AT RISK OF BECOMING HOUSEBOUND [%]” affect “AVERAGE PERIOD OF INDEPENDENCE (YEARS)” with coefficients of “−0.15”, “−0.1”, and “−0.2”, respectively.

FIG. 3 shows an example of showing the final outcome, and each intermediate outcome that significantly contributes to the final outcome, with values of City A, which is the target organization, and values of other organizations that serve as comparable items, in a table format. FIG. 3 shows an example of displaying the values of the final outcome (“AVERAGE PERIOD OF INDEPENDENCE (YEARS)”), and the intermediate outcomes (“RATE OF PEOPLE WITH MOTOR FUNCTION IMPAIRMENT RISK [%]”, “RATE OF PEOPLE WITH ORAL FUNCTION IMPAIRMENT RISK [%]”, and “RATE OF PEOPLE AT RISK OF BECOMING HOUSEBOUND [%]”), which significantly contribute to the final outcome, in a case where “NATIONAL”, “PREFECTURE Z” that is a prefecture to which City A belongs, and “CITY B” that is a municipality designated by the person in charge are applied as other organizations that are such comparable items, and “NATIONAL AVERAGE”, “PREFECTURE Z AVERAGE”, and “CITY B” are applied as the values of the other organizations serving as comparable items. Based on the displayed items, the staff member of City A can compare the value of City A as the target organization, with the values of the other organizations serving as the comparable items, with respect to the final outcome, and each intermediate outcome, which significantly contributes to the final outcome.

Such analysis and comparison using the statistical data allows the staff member of City A to preliminarily know the intermediate outcomes, which are significant to improve the final outcome, and then find, as improvement indicator candidates, those indicators for City A which are inferior to the comparable items among the intermediate outcomes.

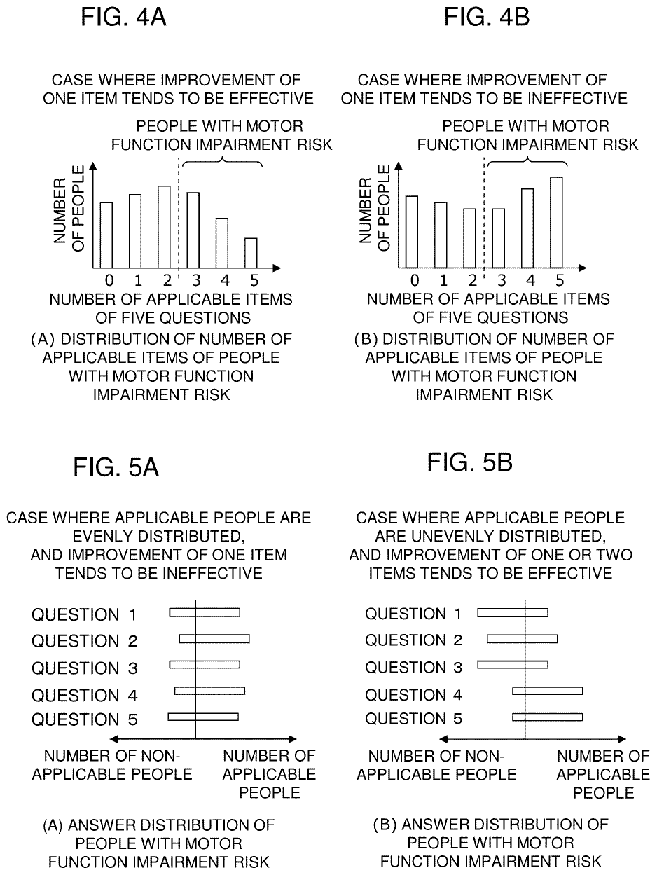

FIGS. 4A and 4B show examples indicating the actual state of City A related to “MOTOR FUNCTION IMPAIRMENT RISK” in graphs from individual data of City A. For example, the survey on preventive care and daily living needs overseen by the Ministry of Health, Labour and Welfare defines people with positive responses to three or more among five questions with respect to the motor function impairment risk, as people with motor function impairment risk. According to such a definition, even when the “RATE OF PEOPLE WITH MOTOR FUNCTION IMPAIRMENT RISK [%]” is the same, there are a case where the indicator “RATE OF PEOPLE WITH MOTOR FUNCTION IMPAIRMENT RISK [%]” is easily improved (FIG. 4A), and a case where improvement of one item tends to be ineffective (FIG. 4B), depending on the distribution.

As shown in FIGS. 5A and 5B, determination of which question the corresponding policy is employed for, whether the number of questions as improvement targets may be one or two, and whether improvement is made evenly can be supported by displaying the answer distribution with respect to each question of the people with motor function impairment risk.

The policy making support function implemented in the policy making support apparatus 3 in the present embodiment is a function of supporting making realistic and effective policies in consideration of the distribution of such individual data.

As described above, the storage device 13 of the policy making support apparatus 3 stores the statistical data database 16 and the individual data database 17, and the improvement indicator candidate extraction program 18 and the improvement effect trial calculation program 19, as measures for achieving such a policy making support function.

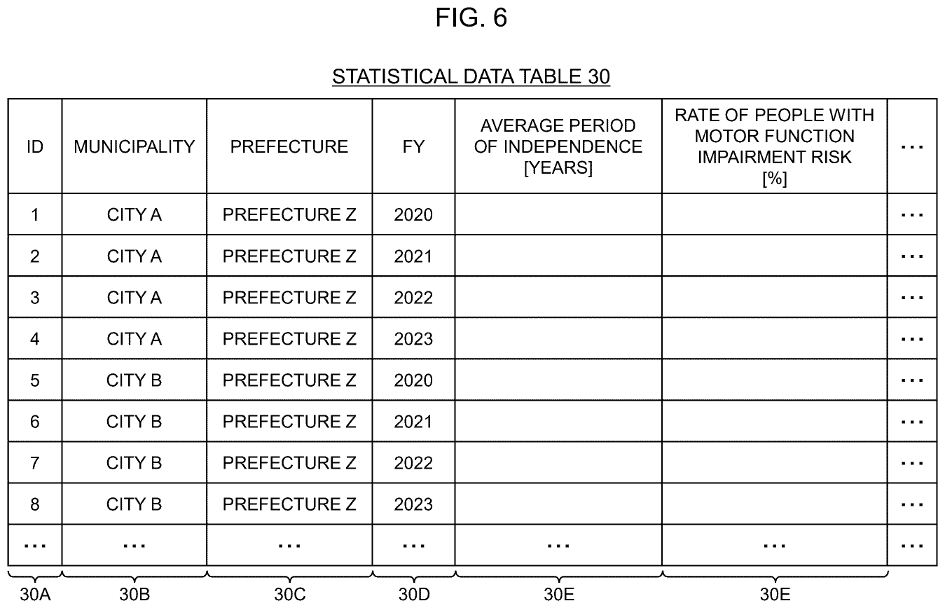

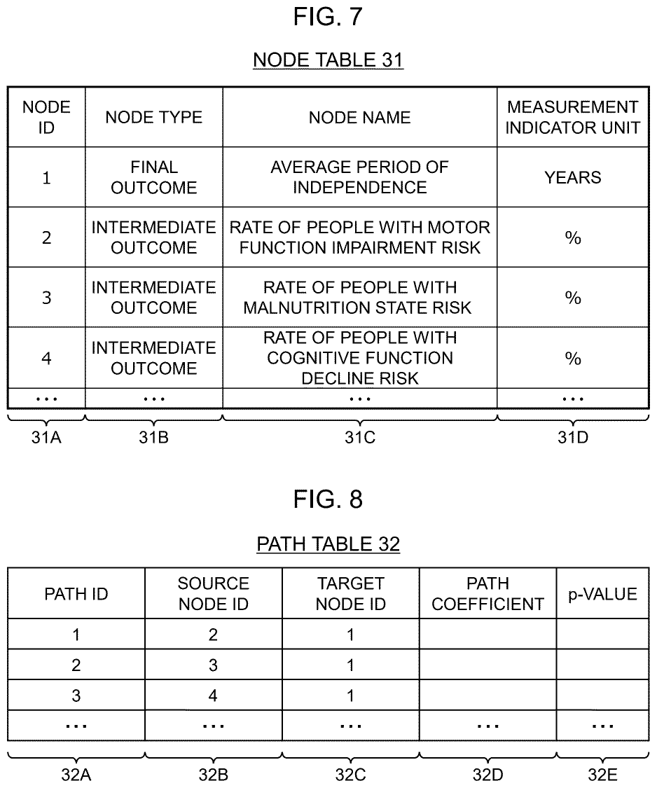

The statistical data database 16 is a database that stores various types of information related to the nursing care insurance services, and includes a statistical data table 30 shown in FIG. 6, a node table 31 shown in FIG. 7, and a path table 32 shown in FIG. 8.

The statistical data table 30 is a table that stores statistical data that is related to policies of nursing care insurance services and has been obtained from public data, and includes an ID field 30A, a municipality field 30B, a prefecture field 30C and a fiscal year (FY) field 30D, and a plurality of statistical value fields 30E, as shown in FIG. 6. In the statistical data table 30, one record (row) corresponds to statistical data in one municipality in one fiscal year.

The ID field 30A stores identifiers that are respectively assigned to the corresponding statistical data items and are unique to these statistical data items. Sequential numbers starting with “1” can be employed as such identifiers. The municipality field 30B stores the names of the corresponding municipalities. The prefecture field 30C stores prefectures in which the municipalities reside. Furthermore, the FY field 30D stores fiscal years in which the corresponding statistical data items are obtained.

The statistical value fields 30E respectively store values (statistical values) of various statistical data items that are obtained in the corresponding fiscal years in the corresponding municipalities. For example, statistical data of indicators that can serve as initial outcomes, intermediate outcomes, and final outcomes of logic models, such as of the average period of independence (years), the rate of people with motor function impairment risk [%], the rate of people with oral function impairment risk [%], the rate of people at risk of becoming housebound [%], the rate of people with malnutrition state risk [%], and the rate of people with cognitive function decline risk [%] can be employed as such statistical values.

The node table 31 is a table in which information related to each of the nodes that include the initial outcomes, intermediate outcomes, and final outcome, and have been preliminarily created based on statistical data obtained so far, and is preliminarily created and provided for the policy making support apparatus 3. As shown in FIG. 7, the node table 31 has a configuration including a node ID field 31A, a node type field 31B, a node name field 31C, and a measurement indicator unit field 31D. In the node table 31, one record corresponds to one node that constitutes the logic model.

The node ID field 31A stores identifiers (node IDs) that are respectively assigned to the corresponding nodes and are unique to the nodes. The node type field 31B stores the types of outcomes that correspond to the nodes among the initial outcomes, intermediate outcomes, and final outcome.

The node name field 31C stores the names (node names) of the corresponding nodes. The measurement indicator unit field 31D stores the units of measurement indicators of the corresponding nodes.

The path table 32 is a table in which information related to the paths that constitute the logic model described above is registered, and preliminarily created and supplied to the policy making support apparatus 3. As shown in FIG. 8, the path table 32 has a configuration including a path ID field 32A, a source node ID field 32B, a target node ID field 32C, a path coefficient field 32D, and a p-value field 32E. In the path table 32, one record corresponds to one path that constitutes the logic model.

The path ID field 32A stores identifiers (path IDs) that are respectively assigned to the corresponding paths and are unique to the paths. The source node ID field 32B stores the node IDs of the nodes that serve as the originating points of the paths. The target node ID field 32C stores the node IDs of the nodes that serve as the end points of the paths. The path coefficient field 32D stores the path coefficients between the source nodes and the target nodes. The p-value field 32E stores the statistical p-values of the path coefficients.

The individual data database 17 is a database that stores individual data that is on a resident-by-resident basis and includes answer content to some question items (hereinafter, they are called questions) to verify the risk related to preventive care. Questions to verify the risk related to preventive care include questions employed in the survey on preventive care and daily living needs described above, question tables for elderly people, basic checklists and the like. Note that the individual data in the individual data database 17 may include basic information on age, gender and the like that is beneficial for narrowing down the number of subjects when a policy is considered as described later.

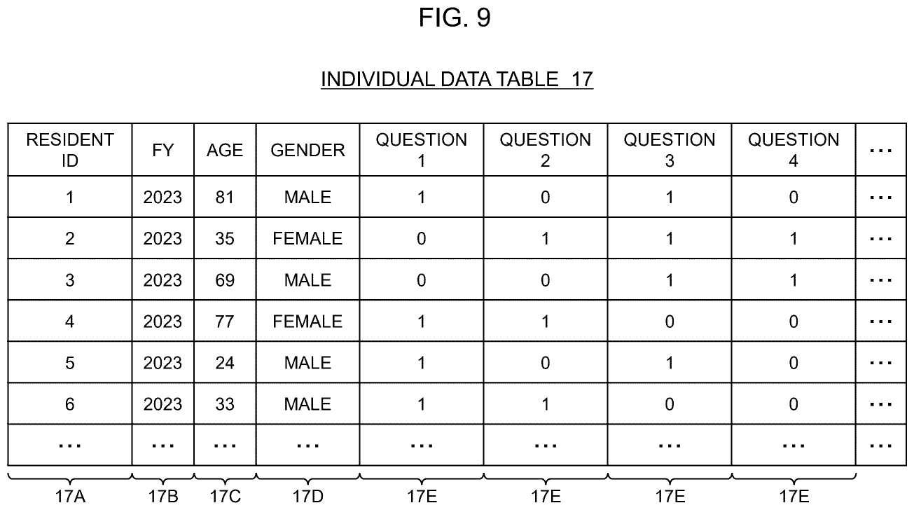

As shown in FIG. 9, the individual data database 17 has a table structure that includes a resident ID field 17A, a FY field 17B, an age field 17C, a gender field 17D, and a plurality of answer fields 17E. In the individual data database 17, one record corresponds to individual data of one resident in a survey (for example, the survey on preventive care and daily living needs) conducted in a certain fiscal year.

The resident ID field 17A stores identifiers (resident IDs) that are respectively assigned to the corresponding residents and are unique to the residents. The FY field 17B stores the fiscal year in which the survey was conducted. The age field 17C and the gender field 17D store the ages and genders of the respective residents.

Furthermore, the answer fields 17E are provided to support the respective questions in the survey that is to verify the risk related to preventive care and was performed in the corresponding fiscal year. Each answer field 17E stores “1” if the answer of the corresponding resident to the corresponding question is an answer determined to have the risk related to preventive care, and “0” if the answer of the corresponding resident to the corresponding question is an answer determined to have no risk related to preventive care.

On the other hand, the improvement indicator candidate extraction program 18 is a program having a function that extracts, as improvement indicator candidates, intermediate outcomes inferior to preset comparable items (e.g., “national average”, “Prefecture Z average”, and “City B” in FIG. 3) from among the intermediate outcomes significantly affecting the final outcome selected by the person in charge (here, the staff member of City A) using the person-in-charge terminal 4, and presents the extracted improvement indicator candidate to the person in charge.

The improvement effect trial calculation program 19 is a program that accepts an improvement margin assumed by the person in charge about each question with respect to the improvement indicator candidates extracted by the improvement indicator candidate extraction program 18, makes a trial calculation of an effect expected when the improvement to the extent of the improvement margin is achieved on a question-by-question basis, and presents the trial calculation to the person in charge.

More specific functions of the improvement indicator candidate extraction program 18 and the improvement effect trial calculation program 19 are described later.

### (1-3) Various Processes Executed in Relation to Policy Making Support Function

Next, the processing details of each process executed in the policy making support apparatus 3 in relation to the aforementioned policy making support function are described. Note that in the following description, it is a matter of course that the description is made assuming the component of performing various processes as the improvement indicator candidate extraction program 18 or the improvement effect trial calculation program 19. In actuality, it is a matter of course that the CPU 11 (FIG. 1) of the policy making support apparatus 3 executes the processes, based on the improvement indicator candidate extraction program 18 or the improvement effect trial calculation program 19.

### (1-3-1) Improvement Indicator Candidate Extraction Process

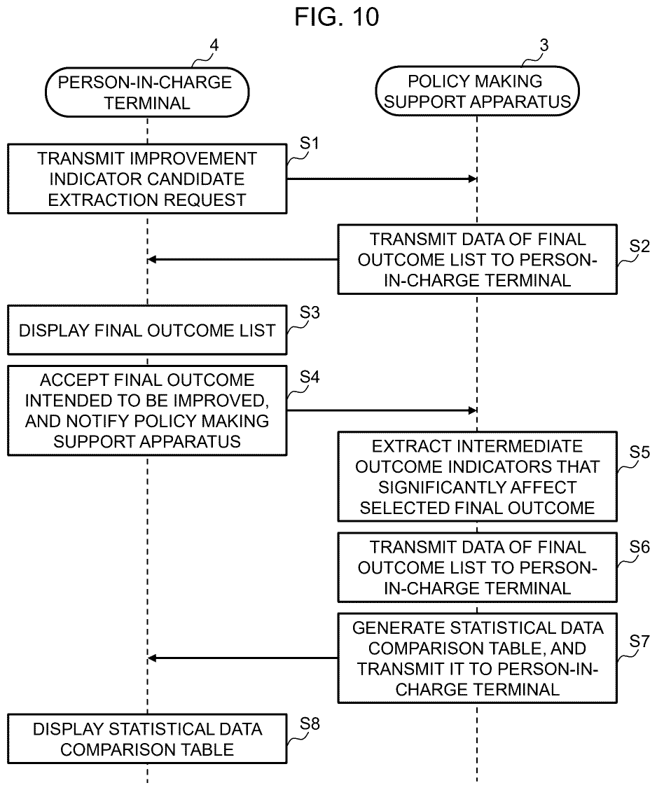

FIG. 10 shows the flow of a series of processes (hereinafter, it is called an improvement indicator candidate extraction process) executed by the policy making support system 1 to extract the improvement indicator candidate described above.

The improvement indicator candidate extraction process is started by the person in charge (here, the staff member of City A) supplying the person-in-charge terminal 4 with an instruction for extracting an improvement indicator candidate (hereinafter, it is called an improvement indicator candidate extraction process) through a predetermined operation. When such an improvement indicator candidate extraction instruction is supplied, the person-in-charge terminal 4 notifies the policy making support apparatus 3 of an improvement indicator candidate extraction request that indicates this instruction (S1).

The improvement indicator candidate extraction program 18 of the policy making support apparatus 3 having received this notification generates a list of final outcomes (hereinafter, this is called a final outcome list), and transmits the generated final outcome list to the person-in-charge terminal 4 (S2).

Specifically, the improvement indicator candidate extraction program 18 refers to the node table 31 (FIG. 7) of the statistical data database 16, and obtains, from the node name field 31C, the node names of nodes where the node type stored in the node type field 31B is “FINAL OUTCOME”, and generates a list of the obtained node names as a final outcome list. The improvement indicator candidate extraction program 18 transmits data of the generated final outcome list to the person-in-charge terminal 4.

On the other hand, when such data of the final outcome list is transmitted from the policy making support apparatus 3, the person-in-charge terminal 4 displays the final outcome list, based on this data (S3). When the person in charge selects the final outcome intended to be improved from the displayed final outcome list, the person-in-charge terminal 4 accepts the selection, and notifies the policy making support apparatus 3 of the selected final outcome (hereinafter, it is called the selected final outcome) (S4).

Upon receipt of the notification of the selected final outcome from the person-in-charge terminal 4, the improvement indicator candidate extraction program 18 of the policy making support apparatus 3 extracts intermediate outcomes that significantly affect the selected final outcome (S5).

Specifically, the improvement indicator candidate extraction program 18 refers to the path table 32 (FIG. 8), employs the selected final outcome as a target, identifies all the paths having the values that are p-values equal to or less than a predefined threshold (for example, 0.05; hereinafter, this is called a p-value threshold), and obtains the source node IDs of the nodes (source nodes) of the intermediate outcomes serving as the originating points of the identified paths. Note that the p-value threshold may be 0.01, 0.1 or the like other than 0.05.

The improvement indicator candidate extraction program 18 obtains, from the node table 31, the node names of the nodes assigned the obtained source node IDs. The nodes having the node names obtained as described above are the intermediate outcomes that significantly affect the selected final outcome. Hereinafter, these intermediate outcome indicators are called the extracted intermediate outcomes.

Subsequently, the improvement indicator candidate extraction program 18 refers to the statistical data table 30, based on the extracted result in step S5, generates the table described above with reference to FIG. 3 (hereinafter, this is called a statistical data comparison table 33), and transmits data of the generated statistical data comparison table 33 to the person-in-charge terminal 4 (S6).

Specifically, the improvement indicator candidate extraction program 18 obtains, from the statistical data table 30 (FIG. 6), the values of the extracted intermediate outcomes of the municipality serving as the target at the time (here, City A, and is hereinafter also called a target municipality as appropriate), and the municipality preliminarily designated as a comparable item (City B in FIG. 3, and hereinafter also called a comparable municipality as appropriate). The improvement indicator candidate extraction program 18 calculates the average of the values of the extracted intermediate outcomes of the municipalities across the country stored in the statistical data table 30, with respect to each of the extracted intermediate outcomes.

The improvement indicator candidate extraction program 18 generates the aforementioned statistical data comparison table 33, based on the values of the extracted intermediate outcomes of the target municipality and the comparable municipality obtained as described above, and on the national average of the extracted intermediate outcomes and the average of the prefecture to which City A belongs, these averages being calculated as described above.

In this case, the improvement indicator candidate extraction program 18 identifies, as the improvement indicator candidates, the extracted intermediate outcomes where the target municipality is specifically inferior to the national average, the average of the prefecture concerned, and the comparable municipality, which are comparable items, and highlights the fields corresponding to the identified extracted intermediate outcomes in the records corresponding to the target municipality in the statistical data comparison table 33, by adding a color or changing the color of displayed characters (e.g., the field of “RATE OF PEOPLE WITH MOTOR FUNCTION IMPAIRMENT RISK [%]” in FIG. 3).

Note that the determination method of whether “the target municipality is specifically inferior to the national average, the average of the prefecture concerned, and the comparable municipality, which are comparable items” may be any of determination methods of whether the value of the extracted intermediate outcome of the target municipality deviates by a predetermined value from the national average, the average of the prefecture concerned, and the value of the comparable municipality or not, and whether the value of the extracted intermediate outcome of the target municipality deviates to exceed the national average, the average of the prefecture concerned, and the variance σ of the values of the comparable municipality or not.

The improvement indicator candidate extraction program 18 then transmits data of the generated statistical data comparison table 33, and data of the analysis result using the logic model shown in FIG. 2, to the person-in-charge terminal 4 (S7).

The person-in-charge terminal 4 displays the analysis result shown in FIG. 2, and the statistical data comparison table 33 shown in FIG. 3, based on the data transmitted from the policy making support apparatus 3. If a highlighted field is present in the statistical data comparison table 33 in this case, the person-in-charge terminal 4 highlights the field by adding a color or changing the color of display characters (S8). Thus, the improvement indicator candidate extraction process is finished.

The improvement indicator candidate extraction process as described above can extract the intermediate outcomes that are statistically superior to the final outcome and inferior to the comparable item, as improvement indicator candidates, and can present them.

### (1-3-2) Improvement Effect Trial Calculation Process

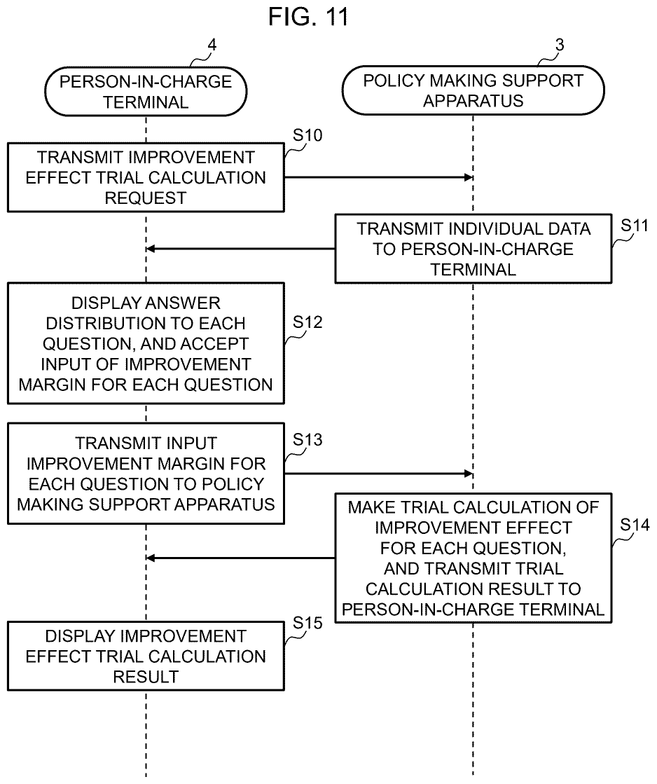

On the other hand, FIG. 11 shows the flow of a series of processes (hereinafter, this is called an improvement effect trial calculation process) executed by the policy making support system 1 to make a trial calculation of the effect in the case where the improvement indicator candidates extracted by the improvement indicator candidate extraction process in FIG. 10 are improved. The improvement effect trial calculation process is started after the improvement indicator candidate extraction process is finished, and then the person in charge inputs an instruction for executing the improvement effect trial calculation process (hereinafter, it is called an improvement effect trial calculation process execution instruction) to the person-in-charge terminal 4.

First, the person-in-charge terminal 4 transmits a request to execute such an improvement effect trial calculation process (hereinafter, it is called an improvement effect trial calculation request), and all the improvement indicator candidates extracted by the improvement indicator candidate extraction process, to the policy making support apparatus 3 (S10).

When such an improvement effect trial calculation request is provided, the policy making support apparatus 3 reads, from the individual data database 17 (FIG. 9), the individual data that is of each resident in the target municipality, and is about each question related to each of the improvement indicator candidates issued as the notification, and transmits the read individual data to the person-in-charge terminal 4 (S11).

When such individual data is provided from the policy making support apparatus 3, the person-in-charge terminal 4 displays the distribution of answers to the questions related to the improvement indicator candidates extracted in the improvement indicator candidate extraction process described above, based on the individual data, with respect to each of the improvement indicator candidates (S12).

Note that the display format of such “distribution of answers to the questions” may be any of a display format of displaying the number of people having given answers of risk-applicable people as a bar graph with respect to the total number of answers corresponding to risk-applicable people as shown in FIGS. 4A and 4B, and a display format of displaying the number of people having given answers corresponding to risk-applicable people, and the number of people having given answers not corresponding to risk-applicable people as positions on the bar on a question-by-question basis as shown in FIGS. 5A and 5B.

For example, FIGS. 4A and 4B are in a display format in which the improvement indicator candidate is “RATE OF PEOPLE WITH MOTOR FUNCTION IMPAIRMENT RISK [%]” and which represents, as bar graphs, the distribution of residents whose total number of questions for which answers corresponding to the motor function impairment risk are selected among total five questions related to the improvement indicator candidate from “0” to “5”. FIGS. 5A and 5B are in a display format representing, as the position of the bar, the answer distribution to each question for the residents with which the improvement indicator candidate corresponds to “RATE OF PEOPLE WITH MOTOR FUNCTION IMPAIRMENT RISK [%]”. The person-in-charge terminal 4 may display “the distribution of answers to the questions related to the improvement indicator candidates” in multiple display formats (for example, in both FIG. 4A or 4B, and FIG. 5A or 5B).

In step S12, the person-in-charge terminal 4 accepts input of the improvement margin for each question related to the displayed improvement indicator candidate. For example, a method of inputting a rate such as “improved by 10%”, and a method of inputting the number of people such as “1,000 people improved” are conceivable as examples of input of the improvement margin. When the improvement margin for each question is input by the person in charge, the person-in-charge terminal 4 notifies the policy making support apparatus 3 of the improvement margin for each question (S13).

The improvement effect trial calculation program 19 of the policy making support apparatus 3 having received the improvement margin obtains the relationship between indicators from the statistical data database 16, makes a trial calculation of the effect expected when the improvement by the received improvement margin is achieved, and transmits the trial calculation result to the person-in-charge terminal 4 (S14).

Specifically, the improvement effect trial calculation program 19 reflects the received improvement margin in the rate of people with risk corresponding to the intermediate outcome of the improvement indicator candidate, on a question-by-question basis, and calculates the improved rate of people with risk. The improvement effect trial calculation program 19 reads, from the path table, the path coefficient of each path coupling the node of each intermediate outcome (including the improvement indicator candidate) that significantly affects the corresponding final outcome, and the node of the final outcome, and makes a trial calculation of the effect for the final outcome using the converted rate of people with risk, and the read path coefficient of each path.

For example, when the improvement indicator candidate is “RATE OF PEOPLE WITH MOTOR FUNCTION IMPAIRMENT RISK [%]” and a policy of improving “QUESTION 1” is performed, first, the improvement effect trial calculation program 19 extracts the individual data of each resident who is in the target municipality and corresponds to the people with motor function impairment risk, from the individual data database 17 (FIG. 9).

Next, if the improvement margin received in step S13 is the rate, the improvement effect trial calculation program 19 changes the value of “QUESTION 1” from “1” to “0” with respect to each of the number of the residents falling under the improvement margin among each of the residents who corresponds to the people with motor function impairment risk. The improvement effect trial calculation program 19 determines whether every resident in the target municipality is a person with motor function impairment risk or not using the changed individual data, and calculates “RATE OF PEOPLE WITH MOTOR FUNCTION IMPAIRMENT RISK [%]” based on the determination result. The improvement effect trial calculation program 19 transmits the thus calculated trial calculation result to the person-in-charge terminal 4.

When the trial calculation result is transmitted from the policy making support apparatus 3, the person-in-charge terminal 4 displays the trial calculation result (S15). The improvement effect trial calculation process is thus finished.

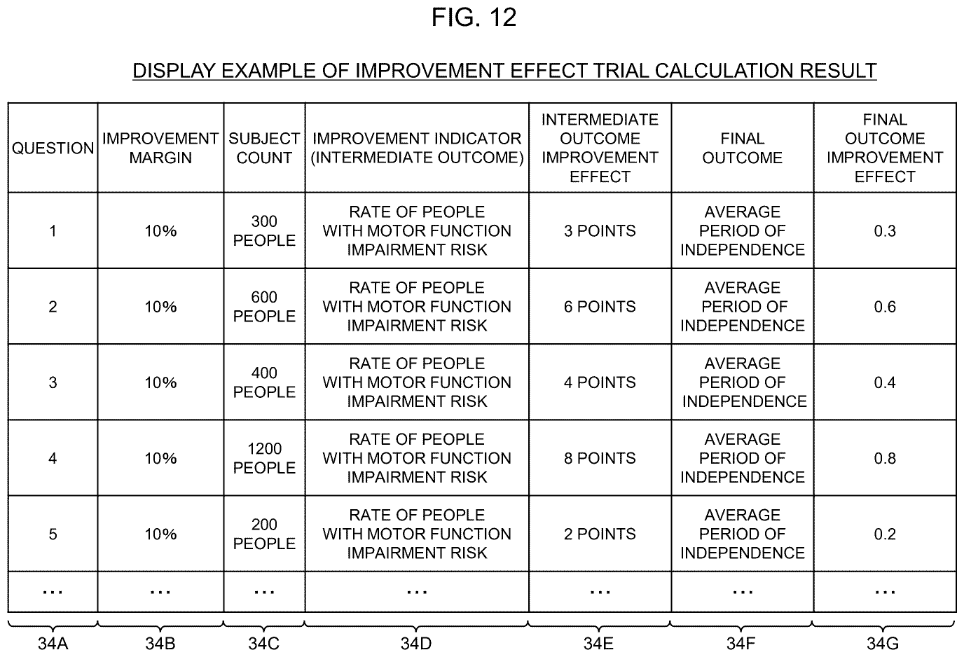

Note that a display example of the trial calculation result displayed on the person-in-charge terminal 4 in step S15 of the improvement effect trial calculation process is shown in FIG. 12. In the display example, such a trial calculation result is displayed in a format of a table that includes a question field 34A, an improvement margin field 34B, a subject count field 34C, an improvement indicator (intermediate outcome) field 34D, an intermediate outcome improvement effect field 34E, a final outcome field 34F, and a final outcome improvement effect field 34G.

The question number of each question related to the improvement indicator candidate extracted by the improvement indicator candidate extraction program 18 through the improvement indicator candidate extraction process described with reference to FIG. 10 is displayed in the question field 34A. The improvement margin designated by the person in charge for the question is displayed in the improvement margin field 34B.

The number of people falling under the designated improvement margin among residents satisfying the intermediate outcome indicator of the improvement indicator candidate is displayed in the subject count field 34C. The node name of the intermediate outcome of the improvement indicator candidate is displayed in the improvement indicator (intermediate outcome) field 34D. Furthermore, the improvement effect of the corresponding intermediate outcome in the case with improvement of the improvement margin stored in the improvement margin field 34B with respect to the corresponding question is displayed in the intermediate outcome improvement effect field 34E.

Moreover, the node name of the final outcome corresponding to the intermediate outcome indicator that is the corresponding improvement indicator candidate is displayed in the final outcome field 34F. The improvement effect of the final outcome in the case where the improvement displayed in the improvement margin field 34B has been made in relation to the corresponding question is displayed in the final outcome improvement effect field 34G.

### (1-4) Advantageous Effects of Present Embodiment

As described above, the policy making support apparatus 3 in the present embodiment extracts the intermediate outcome serving as the improvement indicator candidate using the statistical data related to the policy and the logic model created based on the statistical data, makes a trial calculation of the improvement effect in the case where the extracted improvement indicator candidate has been improved, using the individual data, and displays the trial calculation result.

Consequently, according to this policy making support apparatus 3, the person in charge can easily recognize the intermediate outcome serving as a realistic improvement indicator candidate, and the improvement effect, based on the displayed trial calculation result. Thus, realistic and effective policy making can be supported.

### (2) Second Embodiment

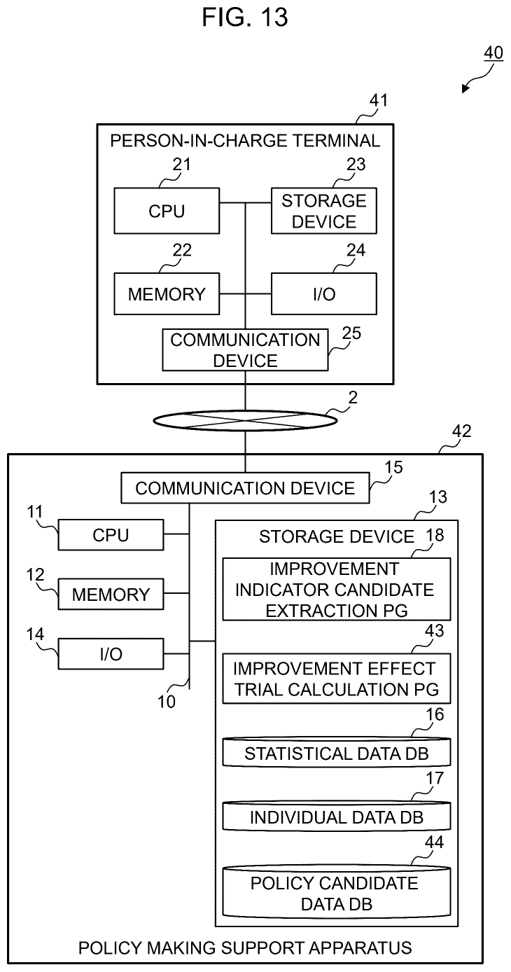

In FIG. 13 where components corresponding to those in FIG. 1 are assigned the same symbols, reference numeral 40 denotes a policy making support system according to a second embodiment as a whole. The policy making support system 40 is different from the policy making support system 1 according to the first embodiment in that in step S15 of the improvement effect trial calculation process described with reference to FIG. 11, the person-in-charge terminal 41 presents policy candidates along with the trial calculation result of the improvement effect.

In actuality, in the policy making support system 40 in the present embodiment, the storage device 13 of the policy making support apparatus 42 stores an improvement indicator candidate extraction program 18, an improvement effect trial calculation program 43, a statistical data database 16, and an individual data database 17, and further stores a policy candidate data database 44.

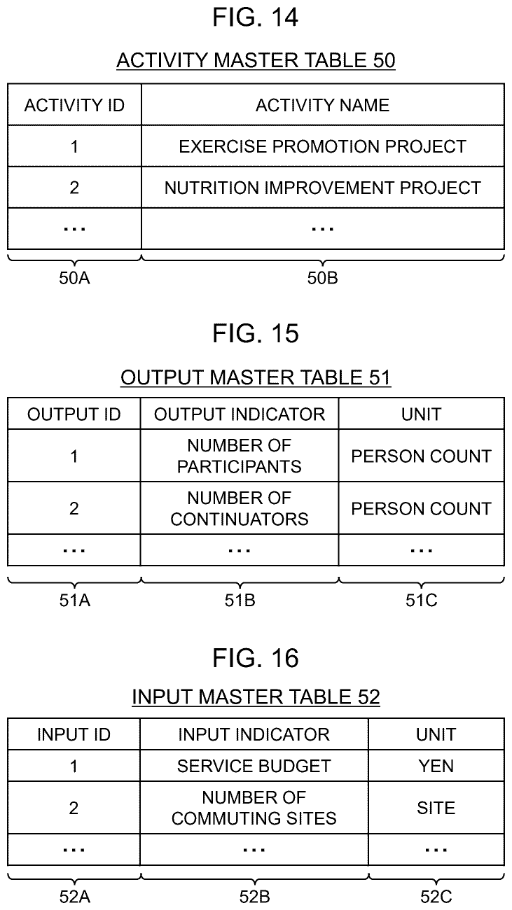

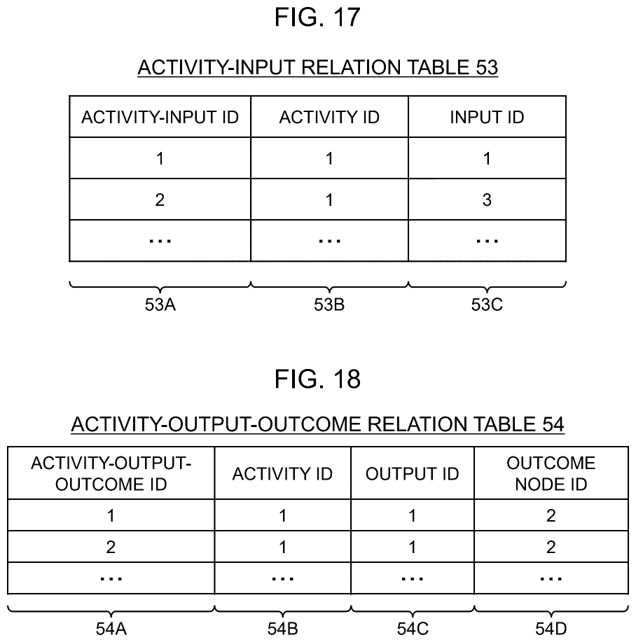

The policy candidate data database 44 is a database that stores various types of data required to display the policy candidate along with the trial calculation result of the improvement effect, and includes an activity master table 50 shown in FIG. 14, an output master table 51 shown in FIG. 15, an input master table 52 shown in FIG. 16, an activity-input relation table 53 shown in FIG. 17, and an activity-output-outcome relation table 54 shown in FIG. 18.

The activity master table 50 is a table for managing various activities (policies and services) that can be executed by an organization (here, the municipality called “City A”) to which the person in charge operating the person-in-charge terminal 4 belongs, and is preliminarily created and supplied to the policy making support apparatus 42. As shown in FIG. 14, the activity master table 50 has a configuration including an activity ID field 50A and an activity name field 50B. In the activity master table 50, one record corresponds to one activity.

The activity ID field 50A stores the identifiers (activity IDs) that are assigned and unique to the respective corresponding activities. The activity name field 50B stores the names of the activities (activity names). Consequently, the case in FIG. 14 shows that for example, the activity with the activity ID of “1” is “EXERCISE PROMOTION PROJECT”.

The output master table 51 is a table for managing information related to various outputs that are results of the activity, and preliminarily created and supplied to the policy making support apparatus 42. As shown in FIG. 15, the output master table 51 has a configuration including an output ID field 51A, an output indicator field 51B, and a unit field 51C. In the output master table 51, one record corresponds to one output.

The output ID field 51A stores the identifiers (output IDs) that are assigned and unique to the respective corresponding outputs. The output indicator field 51B stores the content of each output. The unit field 51C stores the unit of each output.

Consequently, in the case of the example in FIG. 15, the output with the output ID of “1” indicates that the content is “NUMBER OF PARTICIPANTS”, and the unit is “PERSON COUNT”.

The input master table 52 is a table for managing inputs required for the activities, and is preliminarily created and supplied to the policy making support apparatus 42. As shown in FIG. 16, the input master table 52 has a configuration including an input ID field 52A, an input indicator field 52B, and a unit field 52C. In the input master table 52, one record corresponds to one input.

The input ID field 52A stores the identifiers (input IDs) that are assigned and unique to the respective corresponding inputs. The input indicator field 52B stores the content of each input. The unit field 52C stores the unit of each input. Consequently, in the case of the example in FIG. 16, it is shown that the input with an input ID of “1” has content of “SERVICE BUDGET”, and the unit is “YEN”.

The activity-input relation table 53 is a table that stores the relationship between each activity and an input required to the activity, and is preliminarily created and supplied to the policy making support apparatus 42. As shown in FIG. 17, the activity-input relation table 53 has a configuration including an activity-input ID field 53A, an activity ID field 53B, and an input ID field 53C. In the activity-input relation table 53, one record corresponds to the relationship between an activity and an input.

The activity-input ID field 53A stores the identifiers (activity-input IDs) that are each assigned in the activity-input relation table 53 to the corresponding relationship between the activity and the input, and unique to the relationship. The activity ID field 53B stores the activity IDs of the respective corresponding activities. The input ID field 53C stores the input IDs of the respective corresponding inputs.

Consequently, in the case of the example in FIG. 17, it is shown that the relationship between the activity of an activity ID of “1” and the input of an input ID of “1” is assigned an activity-input ID of “1”.

The activity-output-outcome relation table 54 is a table for managing candidates of measures (hereinafter, they are called measure candidates) predefined for the respective improvement indicator candidates, and is preliminarily created and supplied to the policy making support apparatus 42. As shown in FIG. 18, the activity-output-outcome relation table 54 has a configuration including an activity-output-outcome ID field 54A, an activity ID field 54B, an output ID field 54C, and an outcome node ID field 54D. In the activity-output-outcome relation table 54, one record corresponds to one measure candidate for one improvement indicator candidate.

The activity-output-outcome ID field 54A stores the identifiers (activity-output-outcome IDs) that each are assigned in the activity-output-outcome relation table 54 to the corresponding correspondence relationship between the activity, output, and outcome node ID, and is unique to the correspondence relationship.

The outcome node ID field 54D stores the node ID of the node that corresponds to the improvement indicator candidate and is on the logic model. Furthermore, the activity ID field 54B stores the activity ID of each single activity serving as measures for the improvement indicator candidate. The output ID field 54C stores the output ID of an important output of the activity.

Consequently, in the case of the example in FIG. 18, with reference to FIGS. 7, and 14 to 17, in the case where the improvement indicator candidate is “RATE OF PEOPLE WITH MOTOR FUNCTION IMPAIRMENT RISK” (outcome node ID of “2”), “EXERCISE PROMOTION PROJECT” (activity ID of “1”) with the large “NUMBER OF PARTICIPANTS” (output ID of “1”) and/or large “NUMBER OF CONTINUATORS” (output ID of “2”) can serve as measure candidates.

On the other hand, the improvement effect trial calculation program 43 (FIG. 13) in the present embodiment uses such a policy candidate data database 44 to obtain the policy candidate with respect to each improvement indicator candidate in step S14 of the improvement effect trial calculation process described with reference to FIG. 11.

Specifically, the improvement effect trial calculation program 43 identifies the record where the outcome node ID field 54D of the activity-output-outcome relation table 54 stores the node ID of the improvement indicator candidate, with respect to each improvement indicator candidate extracted by the improvement indicator candidate extraction program 18 in the improvement indicator candidate extraction process, and extracts the activity ID stored in the activity ID field 54B and the output ID stored in the output ID field 54C in the record.

The improvement effect trial calculation program 43 searches for the activity master table 50 using the extracted activity ID as a key, thereby obtaining the activity name of the corresponding activity. The improvement effect trial calculation program 43 searches the output master table 51 using the extracted output ID as a key, thereby obtaining the output indicators of all the corresponding outputs. The activity name and output indicators obtained as described above are policy candidates.

In step S14 of the improvement effect trial calculation process, the improvement effect trial calculation program 43 transmits, to the person-in-charge terminal 41, the policy candidates obtained as described above along with the trial calculation result of the improvement effect.

Thus, in step S15 of the improvement effect trial calculation process, the person-in-charge terminal 41 displays the policy candidate with respect to each improvement indicator candidate transmitted from the policy making support apparatus 42, along with the trial calculation result of the improvement effect.

The policy making support system 40 in the present embodiment having the configuration described above can support making realistic and effective policies while further facilitating policy making in comparison with the first policy making support system 1.

### (3) Other Embodiments

Note that in the aforementioned first and second embodiments, the case where the policy making support apparatus 3 is made up of one computer apparatus is described. However, the present invention is not limited thereto. The policy making support apparatus 3 may be made up of a distributed computing system that includes a plurality of computer apparatuses.

In the aforementioned first and second embodiments, the case where the policy making support apparatus 3 and the person-in-charge terminal 4 are separately configured is described. However, the present invention is not limited thereto. The function of the person-in-charge terminal 4 may be implemented in the policy making support apparatus 3, and the policy making support system 1, 40 may be constructed by one computer apparatus (i.e., only the policy making support apparatus).

Furthermore, in the aforementioned first and second embodiments, the present invention is described with the case where the staff member of the municipality City A makes a policy of nursing care insurance services using the policy making support system 1 in the present embodiment is described. However, the present invention is not limited thereto, and is widely applicable to cases of making various policies by EBPM.

Moreover, in the aforementioned first and second embodiments, the case of accepting an input of the improvement margin of each question from the person in charge who is a policy maker, and outputting the trial calculation result of the improvement effect in accordance with the accepted improvement margin is described. However, the present invention is not limited thereto, and may apply the uniform improvement margin preset or designated by the person in charge for every question, to each question for the intermediate outcome of every improvement indicator candidate, make a trial calculation of the improvement effect in accordance with the improvement margin with respect to each intermediate outcome, and cause the person-in-charge terminal 4 to display the intermediate outcome having a high improvement effect on the final outcome, and related individual data.

### INDUSTRIAL APPLICABILITY

The present invention is applicable to a policy making support apparatus that supports EBPM.

### REFERENCE SIGNS LIST

1 . . . Policy making support system, 3 . . . Policy making support apparatus, 4 . . . Person-in-charge terminal, 11, 21 . . . CPU, 16 . . . Statistical data database, 17 . . . Individual data database, 18 . . . Improvement indicator candidate extraction program, 19 . . . Improvement effect trial calculation program, 30 . . . Statistical data table, 31 . . . Node table, 32 . . . Path table, 33 . . . Statistical data comparison table.

1. A policy making support apparatus supporting making a policy, the apparatus comprising:
a storage device that stores a program; and
a processor that executes a predetermined computation process, based on the program stored in the storage device,
wherein the storage device stores
a statistical data database that holds information related to a logic model that includes a final outcome, intermediate outcomes, and initial outcomes, and statistical data related to the policy, and an individual data database that holds individual data items related to the policy, along with the program, and
the processor:
extracts all the intermediate outcomes that significantly affect the final outcome externally selected as an improvement target, based on the logic model and the statistical data, and extracts the intermediate outcome that is inferior to a preset comparable item from among the extracted intermediate outcomes, as an improvement indicator candidate; and
makes a trial calculation of an effect expected when the extracted improvement indicator candidate is improved, and displays a trial calculation result.

2. The policy making support apparatus according to claim 1, wherein the processor
displays information of all the intermediate outcomes that significantly affect the final outcome selected as the improvement target, and highlights information on the extracted improvement indicator candidate.

3. The policy making support apparatus according to claim 1, wherein
candidates of measures corresponding to the intermediate outcomes are predefined with respect to each of the intermediate outcomes, and
the processor
displays a candidate of the policy corresponding to the improvement indicator candidate, along with the trial calculation result of the effect expected when the extracted improvement indicator candidate is improved.

4. The policy making support apparatus according to claim 1, wherein the processor
makes a trial calculation of an effect of improvement corresponding to an improvement margin externally designated or predefined, with respect to the intermediate outcome of the improvement indicator candidate, and displays the trial calculation result.

5. The policy making support apparatus according to claim 4, wherein
the improvement margin is uniformly defined for all the intermediate outcomes, and
the processor
makes a trial calculation of the effect of the improvement corresponding to the improvement margin, with respect to each of the intermediate outcomes, and displays the intermediate outcome having a highest effect of the improvement, and the related individual data item.

6. A policy making support method executed by a policy making support apparatus supporting making a policy,
wherein the policy making support apparatus comprises:
a storage device that stores a program; and
a processor that executes a predetermined computation process, based on the program stored in the storage device, and
the storage device stores:
a statistical data database that holds information related to a logic model that includes a final outcome, intermediate outcomes, and initial outcomes, and statistical data related to the policy, and an individual data database that holds individual data items related to the policy, along with the program; and
the method comprises:
a first step of causing the processor to extract all the intermediate outcomes that significantly affect the final outcome externally selected as an improvement target, based on the logic model and the statistical data, and extract the intermediate outcome that is inferior to a preset comparable item from among the extracted intermediate outcomes, as an improvement indicator candidate; and
a second step of causing the processor to make a trial calculation of an effect expected when the extracted improvement indicator candidate is improved, and display a trial calculation result.

7. The policy making support method according to claim 6,
wherein in the first step, the processor
displays information of all the intermediate outcomes that significantly affect the final outcome selected as the improvement target, and highlights information on the extracted improvement indicator candidate.

8. The policy making support method according to claim 6, wherein
candidates of measures corresponding to the intermediate outcomes are predefined with respect to each of the intermediate outcomes, and
in the second step, the processor
displays a candidate of the policy corresponding to the improvement indicator candidate, along with the trial calculation result of the effect expected when the extracted improvement indicator candidate is improved.

9. The policy making support method according to claim 6,
in the second step, the processor
makes a trial calculation of an effect of improvement corresponding to an improvement margin externally designated or predefined, with respect to the intermediate outcome of the improvement indicator candidate, and displays the trial calculation result.

10. The policy making support method according to claim 9, wherein
the improvement margin is uniformly defined for all the intermediate outcomes, and
in the second step, the processor
makes a trial calculation of the effect of the improvement corresponding to the improvement margin, with respect to each of the intermediate outcomes, and displays the intermediate outcome having a highest effect of the improvement, and the related individual data item.

11. A program causing a computer to execute a process, the computer comprising a storage device that stores a statistical data database that holds information related to a logic model that includes a final outcome, intermediate outcomes, and initial outcomes, and statistical data related to the policy, and an individual data database that holds individual data items related to the policy, wherein the process comprises:
a first step of extracting all the intermediate outcomes that significantly affect the final outcome externally selected as an improvement target, based on the logic model and the statistical data, and extracting the intermediate outcome that is inferior to a preset comparable item from among the extracted intermediate outcomes, as an improvement indicator candidate; and
a second step of making a trial calculation of an effect expected when the extracted improvement indicator candidate is improved, and displaying a trial calculation result.
